(19) United States
(12) Patent Application Publication
(10) Pub. No.: US 2009/0237085 A1
(43) Pub. Date: Sep. 24, 2009

(54) VOLTAGE DETECTION CIRCUIT

(75) Inventor: Daisuke Suto, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/402,068

(22) Filed: Mar. 11, 2009

(30) Foreign Application Priority Data
Mar. 19, 2008 (JP) 2008-071754

(51) Int. Cl. G01N 27/416

(52) U.S. Cl. 324/426

(57) ABSTRACT

A voltage detection circuit 1A comprises a coil 5 connected between positive and negative terminals of a battery 3 through input terminals T1 and T2, and an MR device R_{M} magnetically coupled to the coil 5. Employing such a structure makes it possible to detect the voltage of the battery 3 in real time according to a change of magnetic resistance in the MR device R_{M}.

### BACKGROUND OF THE INVENTION

1. Field of the Invention

The present invention relates to a voltage detection circuit for detecting a voltage of a battery.

2. Related Background Art

As lithium-ion secondary batteries and the like are repeatedly charged and discharged, their charged/discharged voltages with respect to the charged/discharged time may fluctuate. For charging/discharging a secondary battery, it is necessary to forbid the battery from being charged in excess of an upper limit voltage of charging and discharged below a lower limit voltage of discharging from the viewpoints of securing the durability and safety of the battery, whereby a circuit for detecting the voltage of the battery is indispensable. Known as an example of circuits for detecting the voltage is an assembled battery voltage detection apparatus 1 described in Patent Literature 1 (Japanese Patent Application Laid-Open No. 2006-078323). The assembled battery voltage detection apparatus 1, which is of a so-called capacitor type, comprises input-side sampling switches S1 to S9, flying capacitors C1, C2, and output-side sampling switches S10 to S12.

### SUMMARY OF THE INVENTION

However, such an assembled battery voltage detection apparatus 1 detects the voltage through the capacitors C1, C2 by alternately turning on/off the input-side sampling switches S1 to S9 and output-side sampling switches S10 to S12, and thus fails to detect the battery voltage in real time. Also, since the input-side sampling switches S1 to S9 and output-side sampling switches S10 to S12 are necessary, a voltage detection circuit constituting the assembled battery voltage detection apparatus 1 becomes complicated.

In view of such a problem, it is an object of the present invention to provide a voltage detection apparatus which can detect the voltage of each battery in real time with a simple structure.

For achieving the above-mentioned object, the voltage detection circuit in accordance with the present invention comprises a coil connected between positive and negative terminals of a battery, and a magnetoresistive device (MR device) magnetically coupled to the coil.

When a current flows from the battery to the coil in the voltage detection circuit in accordance with the present invention, a magnetic field corresponding to the voltage of the battery is generated in the coil. Since the magnetoresistive device (MR device) is magnetically coupled to the coil, the direction of magnetization of a free layer in the M device varies in response to the strength of the magnetic field generated in the coil, thereby changing magnetic resistance. This makes it possible to detect the voltage of the battery according to the change of magnetic resistance in the MR device. By employing a magnetic coupler scheme including the coil and MR device, the voltage detection circuit in accordance with the present invention can detect the voltage of the battery in real time without providing and alternately turning on/off input- and output-side switches as conventionally done.

Preferably, the voltage detection circuit of the present invention further comprises amplification means for amplifying a signal from the MR device. By amplifying the signal from the MR device by using the amplification means, changes in voltage of the battery can accurately be detected even when the change of magnetic resistance in the MR device is very weak.

The voltage detection circuit in accordance with the present invention can detect the voltage of the battery in real time with a simple structure.

### BRIEF DESCRIPTION OF THE DRAWINGS

FIG. 1 is a diagram schematically illustrating a voltage detection circuit 1A in accordance with an embodiment of the present invention;

FIG. 2 is a schematic diagram for explaining operations of the voltage detection circuit 1A of FIG. 1;

FIG. 3 is a diagram schematically illustrating a voltage detection apparatus 50 using the voltage detection circuit 1A;

FIG. 4 is a flowchart for explaining operations of the voltage detection apparatus 50; and

FIG. 5 is a flowchart for explaining operations of the voltage detection apparatus 50.

### DESCRIPTION OF THE PREFERRED EMBODIMENTS

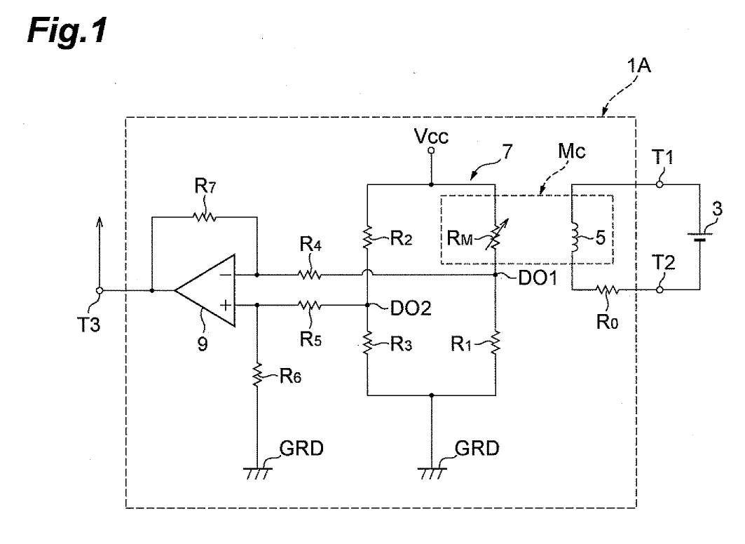

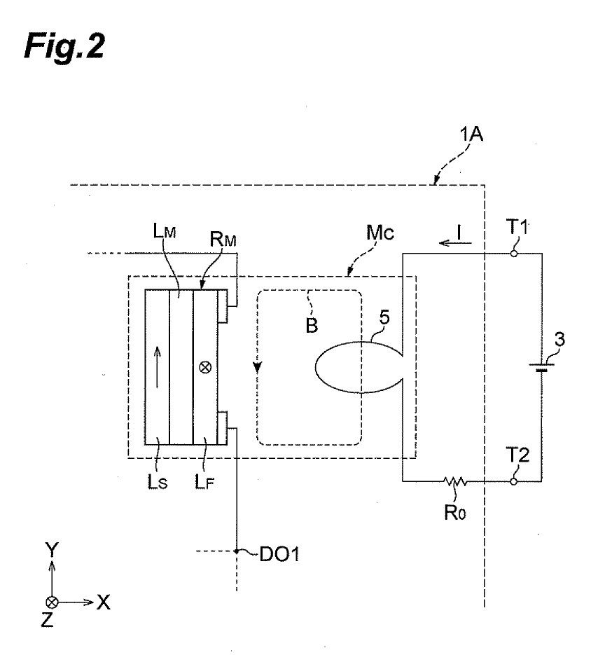

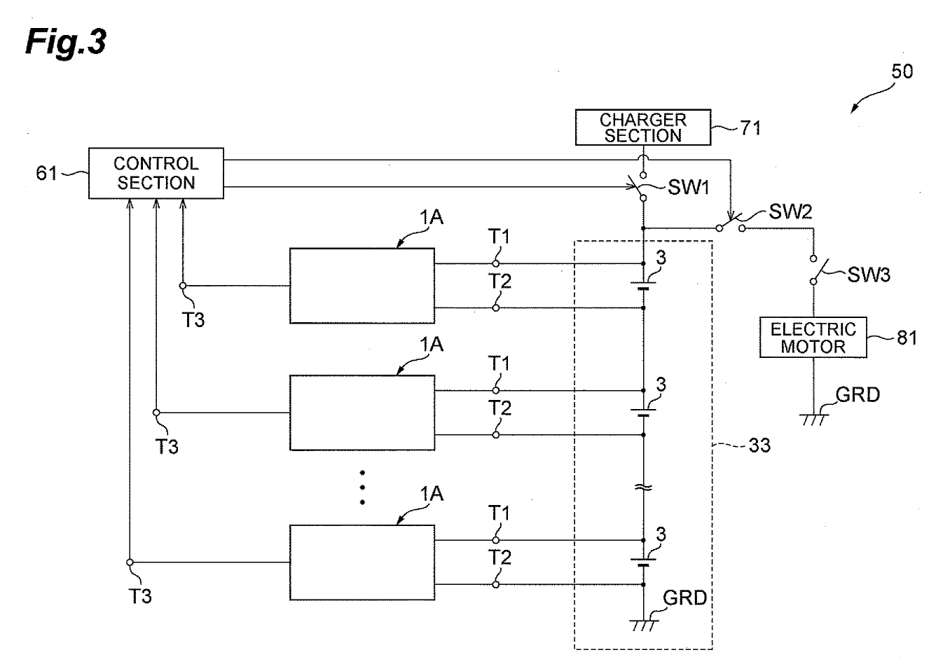

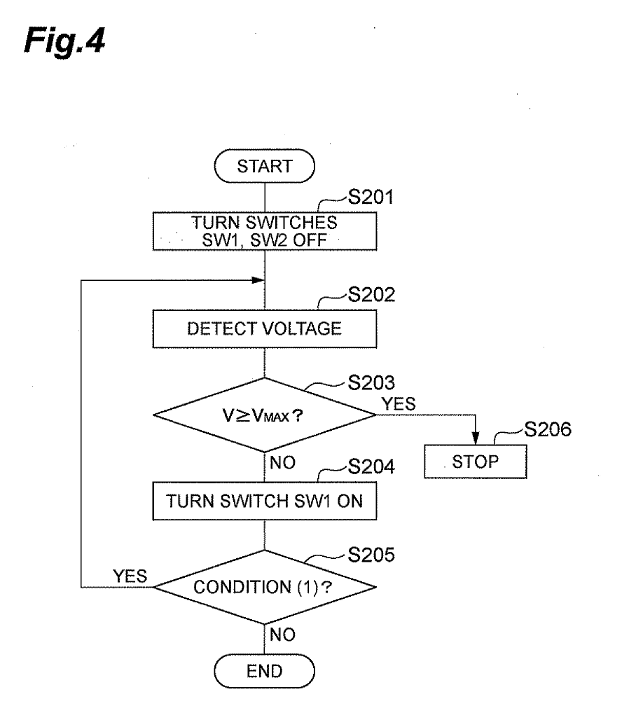

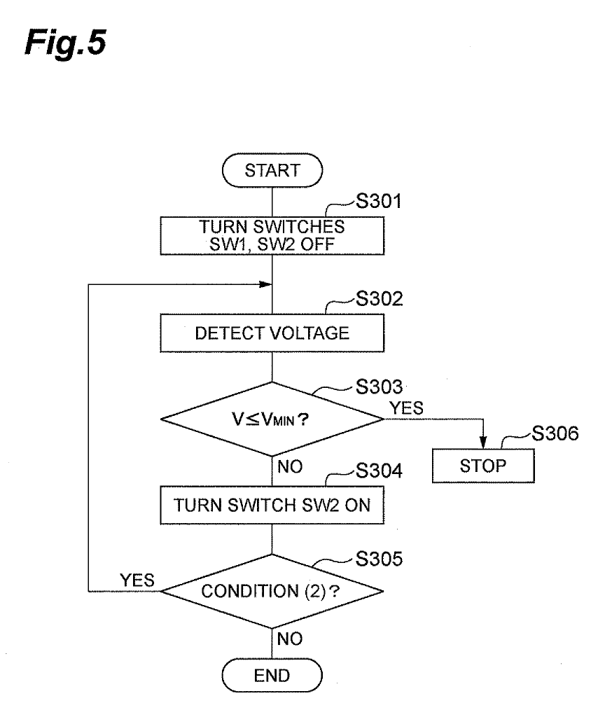

In the following, an embodiment which seems to be the best for carrying out the present invention will be explained in detail with reference to the accompanying drawings. The same or equivalent constituents will be referred to with the same signs while omitting their overlapping descriptions. FIG. 1 is a diagram schematically illustrating a voltage detection circuit 1A in accordance with an embodiment of the present invention. FIG. 2 is a schematic diagram for explaining operations of the voltage detection circuit 1A having a magnetic coupler M_{C}. FIG. 3 is a diagram schematically illustrating a voltage detection apparatus 50 using the voltage detection circuit 1A. FIGS. 4 and 5 are charts for explaining operations of the voltage detection apparatus 50.

As illustrated in FIG. 1, the voltage detection circuit 1A comprises a coil 5 connected between positive and negative terminals of a battery (secondary battery) 3 through input terminals T1, T2, a resistance R₀ connected in series to the coil 5 in order to limit a current I flowing into the coil 5, a bridge circuit 7 including a magnetoresistive device (MR device) R_{M} magnetically coupled to the coil 5, and a differential amplification circuit 9 for amplifying the difference between voltages V1, V2 issued from two output terminals DO1, DO2 of the bridge circuit 7. The differential amplification circuit 9 functions as amplification means for amplifying signals from the MR device R_{M}.

The coil 5 generates a magnetic field in proportion to the magnitude of the current I flowing therethrough. Therefore, a magnetic field corresponding to the voltage V (which is proportional to I) of the battery 3 can be obtained by the coil 5.

The bridge circuit 7, which is electrically insulated from the coil 5, is constituted by first and second resistance series which are connected in parallel. Between a power supply potential Vcc and a ground potential GRD, the M device R_{M} and a resistance R₁ are connected in series in this order as the first resistance series, while resistances R₂ and R₃ are connected in series in this order as the second resistance series. The first output terminal DO1 for outputting the voltage V1 is provided at a junction between the MR device R_{M} and resistance R₁, while the second output terminal DO2 for outputting the voltage V2 is provided at a junction between the resistances R₂ and R₃.

The MR device R_{M}, an example of which is a GMR (Giant Magneto-Resistive) device, is arranged such as to oppose the coil 5. The MR device R_{M} is constituted by a free layer L_{F} which changes its direction of magnetization in response to an external magnetic field, a fixed layer L_{S} having a fixed direction of magnetization, and a nonmagnetic intermediate layer L_{M} interposed between the free layer L_{F} and fixed layer L_{S} (see FIG. 2). In the MR device R_{M}, the direction of magnetization of the free layer L_{F} varies under the influence of the magnetic field generated in the coil 5 in response to the voltage of the battery 3. When the direction of magnetization of the free layer L_{F} varies, the resistance of the M device R_{M} changes, thereby altering the voltage V1 issued from the first output terminal DO1. On the other hand, the voltage V2 from the second output terminal DO2 does not change.

The differential amplification circuit 9 is used for acquiring the difference between the voltage V1 issued from first output terminal DO1 and the voltage V2 issued from the output terminal DO2. The differential amplification circuit 9 has an inverting input terminal connected to the output terminal DO1 through a resistance R₄, and a non-inverting circuit terminal connected to the output terminal DO2 through a resistance R₅. As a consequence, the voltage V1 issued from the first output terminal DO1 is fed to the inverting input terminal of the differential amplification circuit 9, while the voltage V2 issued from the second output terminal DO2 is fed to the non-inverting input terminal of the differential amplification circuit 9. Also, the inverting input terminal is connected to an output terminal through a feedback resistance R₇, while the non-inverting input terminal is connected to the ground potential GRD through a resistance R₆.

Assuming that R₄=R₅ and R₆=R₇, and expressing the resistance values of the resistances by the same polarity sign for convenience, a voltage V_{AMP} issued from the output terminal of the differential amplification circuit 8 is given by (R₇/R₄)×(V2−V1) in this embodiment. Through an output terminal T3 of the voltage detection circuit 1A, the voltage V_{AMP} is fed to a control section 61 which will be explained later.

Specific operations of the voltage detection circuit 1A including the magnetic coupler M_{C} composed of the coil 5 and M device R_{M} will now be explained with reference to FIG. 2. In the MR device R_{M} in accordance with this embodiment, as illustrated in FIG. 2, the direction of magnetization of the fixed layer L_{S} is fixed to the Y direction, while the direction of magnetization that is a magnetization easy axis of the free layer L_{F} is oriented in the Z direction. The nonmagnetic intermediate layer L_{M} is interposed between the fixed layer L_{S} and free layer L_{F}. The nonmagnetic intermediate layer L_{M} is made of a conductor such as Cu in this embodiment, but may be an insulator such as Al₂O₃ or MgO as well.

As illustrated in FIG. 2, when the current I starts to flow in the arrowed direction, a magnetic field (B) (in the −Y direction in the vicinity of the free layer L_{F}) is generated in the coil 5, whereby the magnetic resistance of the MR device R_{M} varies under the influence of the magnetic field. More specifically, as the current I flows, the direction of magnetization of the free layer L_{F} begins to change gradually to the −Y direction (direction opposite from that of magnetization of the fixed layer L_{S}) under the influence of the magnetic field generated in the coil 5. Consequently, the resistance value of the MR device R_{M} increases in proportion to the voltage of the battery 3.

As the magnetic resistance (resistance) of the M device R_{M} increases, the voltage V1 issued from the output terminal D01 of the bridge circuit 7 decreases. As the voltage V1 from the output terminal DO1 decreases, the voltage V_{AMP} [=(R₇/R₄)×(V2−V1)] from the differential amplification circuit 9 becomes greater. Since the voltage V_{AMP} from the differential amplification circuit 9 increases as the voltage of each battery 3 rises as in the foregoing, the voltage of the battery 3 can be detected when appropriately related to the voltage V_{AMP} from the differential amplification circuit 9.

FIG. 3 is a diagram schematically illustrating an assembled battery voltage detection apparatus 50 using the voltage detection circuit 1A. In this system, the voltage detection apparatus 50 comprises voltage detection circuits 1A connected to respective batteries 3 constituting an assembled battery 33 between their positive and negative terminals through input terminals T1 and T2, a charger section 71 for charging the batteries 3, an electric motor (load) 81 for discharging the batteries 3, and a control section 61 for controlling the ON/OFF of switches SW1, SW2.

In this embodiment, the assembled battery 33 is used, for example, as a power supply for the electric motor 81 in an HEV (Hybrid Electric Vehicle) using both an engine (not depicted) and the electric motor 81 as driving sources for running.

Through the switch SW1, the charger section 71 is connected to the positive electrode terminal of the battery 3 constituting one end of the assembled battery 33. The negative electrode terminal of the battery 3 constituting the other end of the assembled battery 33 is connected to the ground potential GRD.

The electric motor 81 has one end connected to the ground potential GRD and the other end connected between the batteries 3 and switch SW1 through the switch SW2. Arranged between the switch SW2 and electric motor 81 is a switch SW3 which can be turned on/off by a user of the HEV.

The control section 61 is one which receives voltage V_{AMP} outputs from the respective differential amplification circuits 9 of the voltage detection circuits 1A in the batteries 3 and controls the ON/OFF of the switches SW1 and SW2 such that each of the batteries 3 neither exceeds an upper limit voltage V_{MAX} nor falls from a lower limit voltage V_{MIN}.

Specifically, during charging, the control section 61 digitally converts the voltage V_{AMP} from the differential amplification circuit 9 of each voltage detection circuit 1A, and compares the resulting digital voltage V_{DIG} with the upper limit voltage V_{MAX} that has been determined and fed beforehand. When the voltage V_{DIG} is not lower than the upper limit voltage V_{MAX} as a result of the comparison, the switch SW1 is turned off, so as to terminate the charging. When the voltage V_{DIG} is lower than the upper limit voltage V_{MAX} while being a usually employed voltage, on the other hand, the switch SW1 is kept in the ON state.

During discharging, on the other hand, the control section 61 digitally converts the voltage V_{AMP} from each differential amplification circuit 9, and compares the resulting digital voltage V_{DIG} with the lower limit voltage V_{MIN} that has been determined and fed beforehand. When the voltage V_{DIG} is not higher than the lower limit voltage V_{MIN} as a result of the comparison, the switch SW2 is turned off, so as to terminate the dischargeable state. When the voltage V_{DIG} is higher than the lower limit voltage V_{MIN} while being a usually employed voltage, on the other hand, the switch SW2 is kept in the ON state.

The control section 61 in this embodiment also functions to control the switch SW1, SW2 such that the voltage V_{DIG} falls within the upper and lower ends of a voltage range usually in use.

Operations of the voltage detection apparatus 50 will now be explained with reference to FIGS. 4 and 5. First, operations of the voltage detection apparatus 50 during charging will be explained with reference to FIG. 4. When charging of the assembled battery 33 is started by a trigger signal issued from the control section 61, the switches SW1 and SW2 are turned off, so as to be initialized (S201). Thereafter, the respective voltage detection circuits 1A of the batteries 3 issue their voltages V_{AMP}(S202). The control section 61 converts the issued voltages V_{AMP} into respective digital voltages V_{DIG}, which are then compared with the upper limit voltage V_{MAX} (S203). When at least one of the voltages V_{DIG} is the upper limit voltage V_{MAX} or higher, the control section 61 stops charging (S206). When all the voltages V_{DIG} are lower than the upper limit voltage V_{MAX}, on the other hand, the control section 61 keeps the switch SW1 in the ON state. When the switch SW1 is kept in the ON state, the control section 61 further determines whether the condition (1) that the voltages are not higher than the upper end of the usually used voltage range is satisfied or not (S205). As a result, the flow returns to S202 when the condition (1) is satisfied, whereas the charging is terminated when the condition (1) is not satisfied.

Operations of the voltage detection apparatus 50 during discharging will now be explained with reference to FIG. 5. When discharging of the assembled battery 33 is started by a trigger signal issued from the control section 61, the switches SW1 and SW2 are turned off, so as to be initialized (S301). Thereafter, the respective voltage detection circuits 1A of the batteries 3 issue their voltages V_{AMP} (S302). The control section 61 converts the issued voltages V_{AMP} into respective digital voltages V_{DIG}, which are then compared with the lower limit voltage V_{MIN} (S303). When at least one of the voltages V_{DIG} is the lower limit voltage V_{MIN} or less, the control section 61 stops discharging (S306). When all the voltages V_{DIG} are higher than the lower limit voltage V_{MIN}, on the other hand, the control section 61 keeps the switch SW2 in the ON state. When the switch SW2 is kept in the ON state, the control section 61 further determines whether the condition (2) that the voltages are not lower than the lower end of the usually used voltage range is satisfied or not (S305). As a result, the flow returns to S302 when the condition (2) is satisfied, whereas the discharging is terminated when the condition (2) is not satisfied.

In the voltage detection circuit 1A in accordance with this embodiment, the coil 5 is connected between the positive and negative terminals of the battery 3. Therefore, a magnetic field corresponding to the voltage of the battery 3 is generated in the coil 5. Also, since the MR device R_{M} is magnetically coupled to the coil 5, the direction of magnetization of the free layer L_{F} in the MR device R_{M} varies in response to the strength of the magnetic field generated in the coil 5, thereby changing the magnetic resistance. This makes it possible to detect the voltage of the battery 3 according to the change of magnetic resistance in the MR device R_{M}. Thus having the magnetic coupler M_{C} constituted by the coil 5 and the MR device R_{M} magnetically coupled to the coil 5 can detect the voltage of the battery 3 in real time with a simple structure without providing and alternately turning on/off input- and output-side switches.

Feeding the differential amplification circuit 9 with the voltages V1 and V2 issued from the respective output terminals DO1 and DO2 between the resistances (R_{M}, R₁; R₂, R₃) in the first and second resistance series constituting the bridge circuit 7 and amplifying the difference between the voltages V1 and V2 can accurately detect changes in voltage of the battery 3 even when the change in resistance of the MR device R_{M} is very weak.

The voltage detection apparatus 50 in accordance with this embodiment also has the control section 61 for converting the respective voltages V_{AMP} issued from the voltage detection circuits 1A into the digital voltages V_{DIG} and controlling the switches SW1, SW2 such that the voltages V_{DIG} neither exceed the upper limit voltage V_{MAX} nor fall from the lower limit voltage V_{MIN}. This can secure the durability and safety of the batteries 3 constituting the assembled battery 33. Further, the control section 61 functions to control the switches SW1, SW2 such that the voltages V_{DIG} fall within the upper and lower ends of the usually used voltage range in the HEV, and thus can secure the durability and safety of each battery 3 more effectively.

Without being restricted to the above-mentioned embodiment, the present invention can be modified in various ways. For example, though the control section 61 converts the voltage V_{AMP} issued from the voltage detection circuit 1A into the digital voltage V_{DIG} and controls the switches SW1, SW2 according to the voltage V_{DIG} that is digital data, the voltage V_{AMP} that is analog data may be fed into an analog comparator or the like without being digitally converted, so as to control the switches SW1, SW2.

Though a GMR device is used as the MR device R_{M} in this embodiment, a tunneling magnetoresistive (TMR) device, for example, may be used without being restricted to the above.

The system illustrated in FIG. 3 comprises the charger section 71 to which a plurality of batteries 3 are connected through the first switch SW1, the load 81 to which the plurality of batteries 3 are connected through the second switch SW2, and the control section 61 for controlling the first and second switches SW1, SW2 according to the results of detection from the individual voltage detection circuits 1A, and thus can be utilized in electric cars and hybrid cars.

What is claimed is:

1. A voltage detection circuit comprising:
a coil connected between positive and negative terminals of a battery and
a magnetoresistive device magnetically coupled to the coil.

2. A voltage detection circuit according to claim 1, further comprising amplification means for amplifying a signal from the magnetoresistive device.

3. A voltage detection circuit according to claim 1, further comprising a bridge circuit including the magnetoresistive device.

4. A voltage detection circuit according to claim 3, further comprising a differential amplification circuit connected between two output terminals of the bridge circuit.

5. A voltage detection circuit according to claim 1, wherein the magnetoresistive device includes:
a free layer having a direction of magnetization changeable by an external magnetic field;
a fixed layer having a fixed direction of magnetization; and
a nonmagnetic intermediate layer interposed between the free layer and the fixed layer.

6. A system comprising a plurality of voltage detection circuits respectively connected to a plurality of batteries;
wherein each of the voltage detection circuits comprises:
a coil connected between positive and negative terminals of a battery; and
a magnetoresistive device magnetically coupled to the coil.

7. A system according to claim 6, further comprising:
a charger section connected to the plurality of batteries through a first switch;
a load connected to the plurality of batteries through a second switch; and
a control section for controlling the first and second switches according to a result of detection from each of the voltage detection circuits.
